(19) United States
(12) Patent Application Publication
(10) Pub. No.: US 2007/0221048 A1
(43) Pub. Date: Sep. 27, 2007

(54) Audio processing system capable of comparing audio signals of different sources and method thereof

(75) Inventors: Hung-Yuan Li, Taipei City (TW); Wen-Wei Tsai, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/713,676

(22) Filed: Mar. 5, 2007

(30) Foreign Application Priority Data
Mar. 13, 2006 (TW) 095108399

(51) Int. Cl. G10H 7/00

(52) U.S. Cl. 84/616

(57) ABSTRACT

An audio processing system includes a first audio detecting device for detecting a first audio signal stored in a storage module and a beat length of the first audio signal, a second audio detecting device for detecting a second audio signal and a beat length of the second audio signal, and a processor coupled to the first audio detecting device and the second audio detecting device for transforming the first audio signal and the beat length of the first audio signal and the second audio signal and the beat length of the second audio signal into corresponding information.

### BACKGROUND OF THE INVENTION

1. Field of the Invention

The present invention relates to an audio processing system and method thereof, and more particularly, to an audio processing system capable of comparing audio signals of different sources and method thereof.

2. Description of the Prior Art

In this busy industrial and commercial society, people like to get together to have fun and relax with friends. Activities such as karaoke are good ways for people to get together and enjoy singing. However, the conventional karaoke system only can display a beat length of words of a song on a screen. When people learn new songs on the conventional karaoke system and cannot get the right key or the right beat for a certain part, they can find it difficult to understand the nature of the wrong key or the wrong beat and the difference between the key and the beat of the sound generated by them and the key and the beat of the original song.

### SUMMARY OF THE INVENTION

It is therefore a primary objective of the claimed invention to provide an audio processing system capable of comparing audio signals of different sources and method thereof for solving the above-mentioned problem.

According to the claimed invention, an audio processing system includes a first audio detecting device for detecting a first audio signal stored in a storage module and a beat length of the first audio signal, a second audio detecting device for detecting a second audio signal and a beat length of the second audio signal, and a processor coupled to the first audio detecting device and the second audio detecting device for transforming the first audio signal and the beat length of the first audio signal and the second audio signal and the beat length of the second audio signal into corresponding information.

According to the claimed invention, a method for processing audio signals from different sources includes the following steps: detecting a first audio signal stored in a storage module and a beat length of the first audio signal; detecting a second audio signal and a beat length of the second audio signal; transforming the first audio signal and the beat length of the first audio signal and the second audio signal and the beat length of the second audio signal into corresponding information; and displaying the corresponding information of the first audio signal and the beat length of the first audio signal and the second audio signal and the beat length of the second audio signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an audio processing system of an embodiment of the present invention.

FIG. 2 is a diagram of audio signals of a song and vocalist displayed on a display device of the audio processing system of the embodiment of the present invention.

FIG. 3 is a flowchart of the audio processing system processing the audio signals shown in FIG. 2 of the embodiment of the present invention.

### DETAILED DESCRIPTION

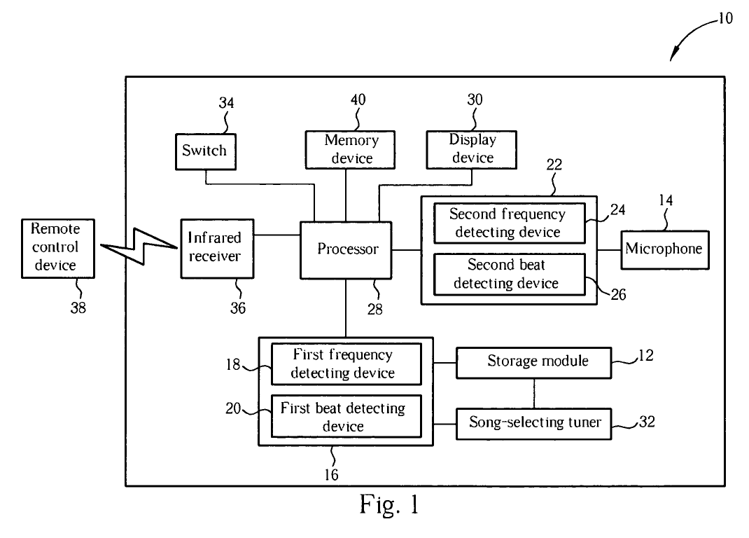

Please refer to FIG. 1. FIG. 1 is a functional block diagram of an audio processing system 10 of an embodiment of the present invention. The audio processing system 10 can be a karaoke system. The audio processing system 10 includes a storage module 12, a microphone 14, a first audio detecting device 16, a second audio detecting device 22, a processor 28, a display device 30, a song-selecting tuner 32, a switch 34, an infrared receiver 36, and a memory device 40.

The storage module 12 is capable of storing data of songs and can be an optical storage device, such as a DVD, a VCD, or a hard disk. The microphone 14 is for receiving audio signals. The first audio detecting device 16 is for detecting audio signals stored in the storage module 12. The first audio detecting device 16 includes a first frequency detecting device 18 for detecting a frequency of the audio signal stored in the storage module 12, and a first beat detecting device 20 for detecting a beat length of the audio signal stored in the storage module 12. A pitch of the audio signal depends on the frequency, that is, audio signals with the same pitch are in the same frequency. For example, if a frequency of 1 KHz lasts for 0.5 seconds, the beat length of the pitch corresponding to the frequency of 1 KHz is 0.5 seconds. Similarly, if a frequency of 1.2 KHz lasts for 0.3 seconds, the beat length of the pitch corresponding to the frequency of 1.2 KHz is 0.3 seconds.

The second audio detecting device 22 coupled to the microphone 14 is for detecting audio signals transmitted from the microphone 14. The second audio detecting device 22 includes a second frequency detecting device 24 for detecting a frequency of the audio signal transmitted from the microphone 14, and a second beat detecting device 26 for detecting a beat length of the audio signal transmitted from the microphone 14.

The processor 28 is for processing audio signals. The display device 30, which can be a television, coupled to the processor 28 is for displaying corresponding information of the audio signals detected by the first audio detecting device 16 and the second audio detecting device 22. The song-selecting tuner 32 is for selecting the audio signal stored in the storage module 12. The switch 34 is for switching on or off the audio processing system 10. The infrared receiver 36 is for receiving remote control signals transmitted from a remote control device 38. The memory device 40 is for storing detecting results of the first audio detecting device 16 and the second audio detecting device 22.

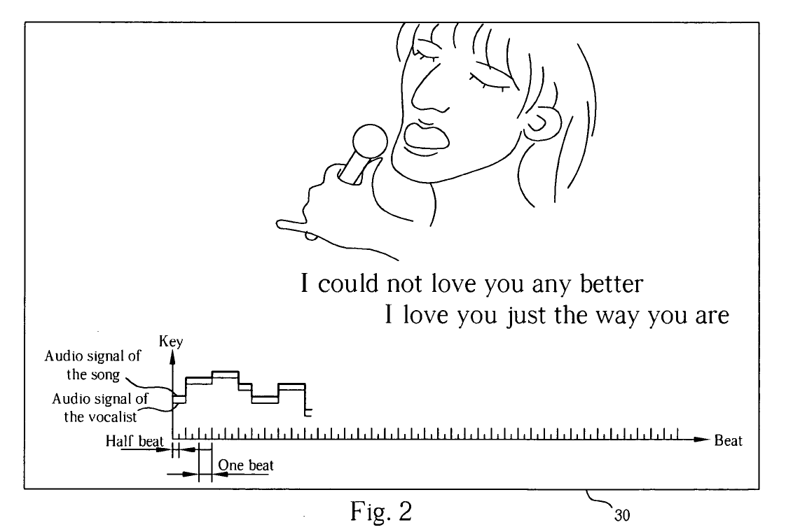

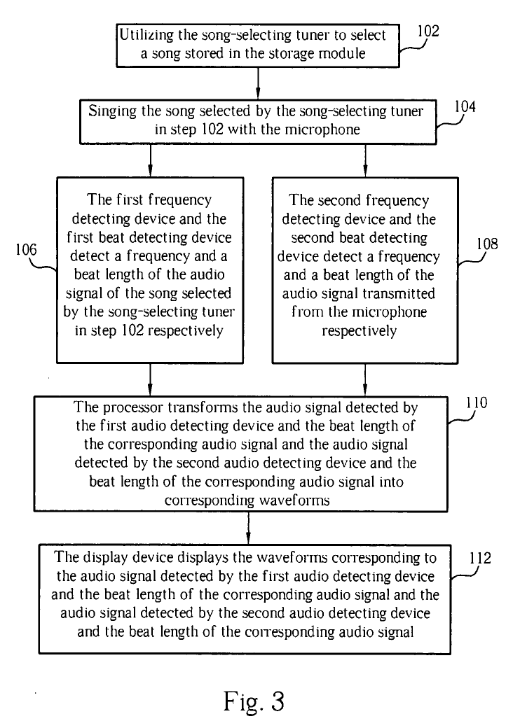

Please refer to FIG. 2. FIG. 2 is a diagram of the audio signals of the song and the vocalist displayed on the display device 30 of the audio processing system 10 of the embodiment of the present invention. The display device 30 is capable of displaying a key and a beat length of every word of the song and a key and a beat length of every word sang by the vocalist simultaneously. A word might correspond to a key or a plurality of keys in a slow song. The vocalist can realize the difference between the original song and the vocal version according to the audio signals displayed on the display device 30. Please refer to FIG. 3. FIG. 3 is a flowchart of the audio processing system 10 processing the audio signals shown in FIG. 2 of the present invention. The method includes the following steps:
Step 102: The vocalist utilizes the song-selecting tuner 32 to select a song stored in the storage module 12.
Step 104: The vocalist sings the song selected by the song-selecting tuner 32 in step 102 with the microphone 14.
Step 106: The first frequency detecting device 18 and the first beat detecting device 20 of the first audio detecting device 16 detect a frequency and a beat length of the audio signal of the song selected by the song-selecting tuner 32 in step 102 respectively.
Step 108: The second frequency detecting device 24 and the second beat detecting device 26 of the second audio detecting device 22 detect a frequency and a beat length of the audio signal transmitted from the microphone 14 respectively.
Step 110: The processor 28 transforms the audio signal detected by the first audio detecting device 16 and the beat length of the corresponding audio signal and the audio signal detected by the second audio detecting device 22 and the beat length of the corresponding audio signal into corresponding waveforms and then transmits signals corresponding to the corresponding waveforms to the display device 30.
Step 112: The display device 30 displays the waveforms corresponding to the audio signal detected by the first audio detecting device 16 and the beat length of the corresponding audio signal and the audio signal detected by the second audio detecting device 22 and the beat length of the corresponding audio signal.

First, the vocalist can utilize the song-selecting tuner 32 to select the song stored in the storage module 12. The song-selecting tuner 32 can generate a selecting signal corresponding to the song for selecting the song. The remote control device 32 can remotely control the song-selecting tuner 32 to select the song in a wireless communication.

After selecting the song, the first audio detecting device 16 receives the audio signal of the song transmitted from the storage module 12. The first frequency detecting device 18 and the first beat detecting device 20 detect the frequency and the beat length of the audio signal of the song respectively and transmit the detecting results to the processor 28.

Simultaneously, the vocalist sings the song with the microphone 14, and the second audio detecting device 22 receives the audio signal transmitted from the microphone 14. The second frequency detecting device 24 and the second beat detecting device 26 detect the frequency and the beat length of the audio signal produced by the vocalist respectively and transmit the detecting results to the processor 28.

The processor 28 transforms the audio signal detected by the first audio detecting device 16 and the beat length of the corresponding audio signal and the audio signal detected by the second audio detecting device 22 and the beat length of the corresponding audio signal into corresponding waveforms, and then transmits signals corresponding to the corresponding waveforms to the display device 30. The processor 28 controls the display device 30 to display the waveform corresponding to the audio signal detected by the first audio detecting device 16 and the waveform corresponding to the audio signal detected by the second audio detecting device 22 simultaneously, as shown in FIG. 2. That is, the display device 30 can display the key and the beat length of the audio signal of the song and the key and the beat length of the audio signal produced by the vocalist on the same frame simultaneously so that the vocalist can realize the difference between the original song and the vocal version according to the waveforms of the audio signals. In addition, the processor 28 can output the detecting results of the first audio detecting device 16 and the second audio detecting device 22 to the memory device 40, and the memory device 40 is capable of storing the detecting results so that the vocalist can compare his/her vocal version and the original song later.

In contrast with the conventional audio processing system and method thereof, the audio processing system and method of the present invention can display the key and the beat length of the song and the key and the beat length sang by the vocalist on the same frame simultaneously, so that the vocalist can realize differences between the original song and the vocal version according to the waveforms of the audio signals for correcting wrong key and beat. The present invention provides a powerful teaching function for an audio processing system, such as a karaoke system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio processing system comprising:
a first audio detecting device for detecting a first audio signal stored in a storage module and a beat length of the first audio signal;
a second audio detecting device for detecting a second audio signal and a beat length of the second audio signal; and
a processor coupled to the first audio detecting device and the second audio detecting device for transforming the first audio signal and the beat length of the first audio signal and the second audio signal and the beat length of the second audio signal into corresponding information.

2. The audio processing system of claim 1 wherein the first audio detecting device comprises a first frequency detecting device for detecting a frequency of the first audio signal and a first beat detecting device for detecting a beat length of the first audio signal.

3. The audio processing system of claim 1 wherein the second audio detecting device comprises a second frequency detecting device for detecting a frequency of the second audio signal and a second beat detecting device for detecting a beat length of the second audio signal.

4. The audio processing system of claim 1 further comprising a memory device for storing the corresponding information processed by the processor according to the first audio signal and the beat length of the first audio signal and the second audio signal and the beat length of the second audio signal.

5. The audio processing system of claim 4 further comprising a song-selecting tuner for selecting the corresponding information of the first audio signal and the beat length of the first audio signal and the second audio signal and the beat length of the second audio signal stored in the memory device.

6. The audio processing system of claim 1 further comprising a display device coupled to the processor for displaying the corresponding information.

7. A method for processing audio signals from different sources comprising:
detecting a first audio signal stored in a storage module and a beat length of the first audio signal;
detecting a second audio signal and a beat length of the second audio signal;
transforming the first audio signal and the beat length of the first audio signal and the second audio signal and the beat length of the second audio signal into corresponding information; and
displaying the corresponding information of the first audio signal and the beat length of the first audio signal and the second audio signal and the beat length of the second audio signal.

8. The method of claim 7 further comprising storing the corresponding information of the first audio signal and the beat length of the first audio signal and the second audio signal and the beat length of the second audio signal.

9. The method of claim 7 further comprising displaying the corresponding information of the first audio signal and the beat length of the first audio signal and the second audio signal and the beat length of the second audio signal according to a selecting signal.
